(19) United States
(12) Patent Application Publication
(10) Pub. No.: US 2017/0220676 A1
(43) Pub. Date: Aug. 3, 2017

(54) METHOD OF PROVIDING SEARCH RESULTS AND SYSTEM FOR PERFORMING THE METHOD

(71) Applicant: NAVER CORPORATION, Seongnam-si Gyeonggi-do (KR)

(72) Inventor: Chun Sik KANG, Seongnam-si (KR)

(73) Assignee: NAVER corporation, Seongnam-si (KR)

(21) Appl. No.: 15/119,320

(22) PCT Filed: Feb. 16, 2015
(86) PCT No.: PCT/KR2015/001585

§ 371 Date: Aug. 16, 2016

(30) Foreign Application Priority Data
Feb. 17, 2014 (KR) 10-2014-0017870

(51) Int. Cl. G06F 17/30

(52) U.S. Cl. CPC G06F 17/30696; G06F 17/30648

(57) ABSTRACT

Disclosed are a method of providing search results and a system for performing the method. A search result providing method may include generating a preferred collection list associated with a keyword using one or more selected collections; and sorting and providing search results about the keyword in the preferred collection list.

### CROSS REFERENCE TO RELATED APPLICATIONS

This is a National Stage Application under 35 U.S.C. §371 of International Application No. PCT/KR2015/001585, filed Feb. 16, 2015, which claims priority under 35 U.S.C. §119 to Korean Application No. 10-2014-0017870, filed Feb. 17, 2014, the entire contents of both of which are hereby incorporated herein by reference.

### TECHNICAL FIELD

One or more example embodiments relate to a search result providing method and system for classifying and providing integrated search results using a plurality of collections.

### RELATED ART

A search engine refers to software or a website that helps users to easily retrieve data on the Internet. The search engine searches a database in response to a keyword input from a user, extracts search results about the keyword, and provides the search results to the user.

As technology associated with a method of providing a search result, Korean Patent Publication No. 10-2004-0052210, published on Jun. 22, 2004, discloses technology for selling a keyword through a bidding and generating a search result list using a selling result.

The search engine extracts, from a database, search results including a keyword transmitted from a user terminal through a search page, generates a search result page, and transmits the search result page to the user terminal.

The search engine extracts, from a database, search results including a keyword based on a matching level between the keyword and the search results, and generates, that is, configures a search result page. Here, a search result corresponding to a high matching level ranks at a relatively high position of the search result page.

However, if a large number of search results are retrieved in association with a keyword such as in an integrated search, a method of sequentially displaying search results in a simple fashion may have an issue that the visibility of a search result page is degraded. A user may need to sequentially verify search results of the search result page one by one in order to retrieve a desired search result.

As a related art to outperform the above issue, there is a method of conducting an integrated search in response to a search request received from a user, and sorting and providing results of the integrated search in preset order of collections, for example, cafe, blog, document, library, dictionary, news, image, etc.

In many existing integrated search methods, since a plurality of collections is fixably sorted or displayed based on a rule of a service provider and, the same search results may be provided to all of search users. That is, the existing search methods may not meet the individual requirements for selecting and viewing a preferred search area.

### DETAILED DESCRIPTION

### Technical Subject

One or more example embodiments provide a search result providing method and system that may selectively display a preferred collection for each user among integrated search results.

One or more example embodiments also provide a search result providing method and system that enables a user to directly determine whether to display a search area.

### Solution

According to at least some example embodiments, there is provided a search result providing method configured as a computer, the method including generating a preferred collection list associated with a keyword using one or more selected collections; and sorting and providing search results about the keyword in the preferred collection list.

According to an aspect, the search result providing method may further include providing a function of determining whether to perform a display for each collection of entire collections, prior to generating.

According to another aspect, the providing of the function of determining whether to perform a display may include providing statistical information associated with the collection for each collection.

According to still another aspect, the providing of the function of determining whether to perform a display may include recommending one or more collections selected from among the entire collections based on personal information.

According to still another aspect, the providing of the function of determining whether to perform a display may include providing a function of setting order of a collection in response to selecting a plurality of collections.

According to still another aspect, the search result providing method may further include providing a function of setting a range of a keyword for applying the preferred collection list, prior to generating.

According to still another aspect, the generating may include generating the preferred collection list in response to an input of the keyword together with a predefined identifier.

According to still another aspect, the providing may include marking a collection present in the preferred collection list among entire collections associated with the keyword to be in an unfold state in which search results are displayed and marking a collection absent in the preferred collection list to be in a fold state in which abstract information including a name of the collection is displayed and search results are not displayed.

According to still another aspect, the providing may include providing a function of switching a state between the unfold state and the fold state for each collection with respect to the entire collections associated with the keyword.

According to still another aspect, the providing may include marking a collection present in the preferred collection list among entire collections associated with the keyword to be in an unfold state in which search results are displayed and marking a collection absent in the preferred collection list to be in a hidden state in which all of information about the collection is hidden.

According to at least some example embodiments, there is provided a search result providing system including a configuring device configured to generate a preferred collection list associated with a keyword using one or more selected collections; and a provider configured to sort and provide search results about the keyword in the preferred collection list.

### Advantageous Effect

According to some example embodiments, since a user may directly select a preferred collection and a non-preferred collection from among integrated search results, it is possible to provide an individual-oriented search area.

According to some example embodiments, since search results may be provided based on collection information selected in response to a user selection on a preferred collection, it is possible to enhance a service satisfaction and the quality of integrated search by applying user requirements for search results.

### BRIEF DESCRIPTION OF DRAWINGS

FIG. 1 is a diagram illustrating a relationship between a user terminal and a search result providing system according to at least one example embodiment;

FIG. 2 is a flowchart illustrating a method of providing search results based on user preferred collections according to at least one example embodiment;

FIGS. 3 through 5 illustrate examples of a process of selecting a preferred collection in an integrated search environment according to at least one example embodiment;

FIG. 6 is a flowchart illustrating a method of providing search results based on user preferred collections according to at least one example embodiment; and

FIG. 7 is a block diagram illustrating a configuration of a user terminal according to at least one example embodiment.

### MODE

Hereinafter, example embodiments will be described with reference to the accompanying drawings.

Example embodiments relate to a search engine system that provides search results corresponding to a search query input from a user.

In the present specification, the term “document” may indicate data to be searched at a search engine, and may include typical data, such as a database (DB) and atypical data, such as web data in a blog, a bulletin board, etc. The term “collection” may indicate an area for classifying and thereby displaying documents extracted as search results based on a source, a type, and the like, of a corresponding document. For example, a collection may be classified into a search area, such as a cafe, a blog, a document, a library, a dictionary, news, an image, and the like.

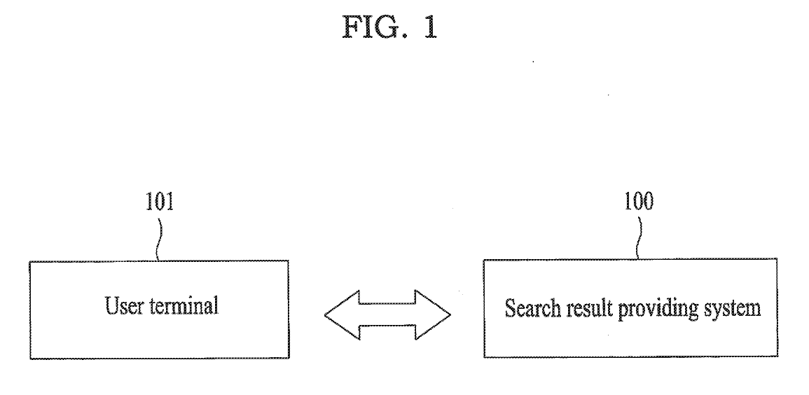

FIG. 1 is a diagram illustrating a relationship between a user terminal and a search system according to at least one example embodiment. FIG. 1 illustrates a search result providing system 100 and a user terminal 101. In FIG. 1, indicators with arrowheads may indicate that data may be transmitted and received between the search result providing system 100 and the user terminal 101 over a wired/wireless network.

The user terminal 101 may refer to any type of terminal devices, for example, a personal computer (PC), a smartphone, a tablet, etc., capable of connecting to a website/mobile site associated with the search result providing system 100, and installing and executing a service exclusive application. Here, the user terminal 101 may perform the overall service operation, such as a service screen configuration, a data input, a data transmission/reception, a data storage, etc., under control of the website/mobile site or the exclusive application.

The search result providing system 100 serves to provide search results corresponding to a keyword input from a user. In particular, the search result providing system 100 may add a function capable of selecting a user preferred collection from a search page or a personalized page, and providing search results that include only user preferred collections in response to an integrated search.

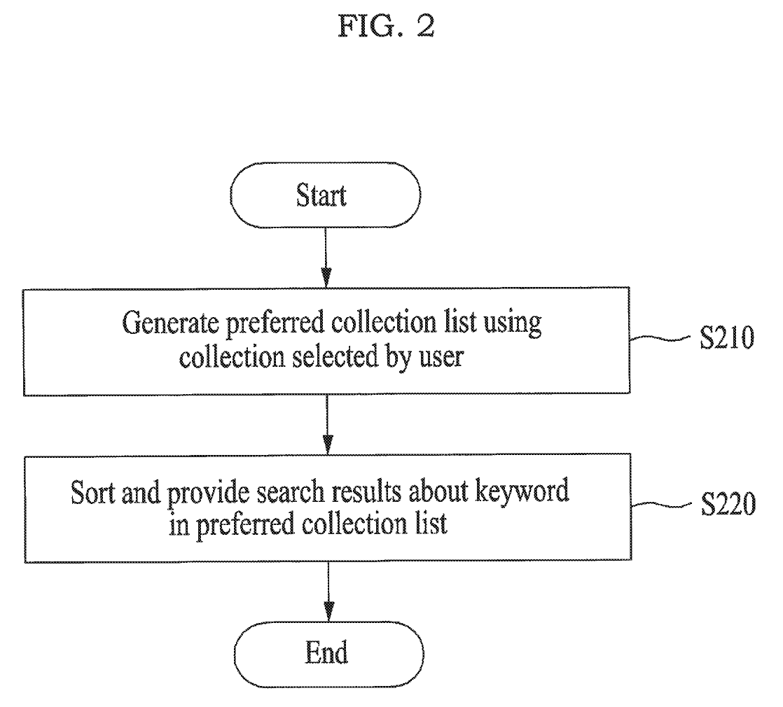

FIG. 2 is a flowchart illustrating a method of providing search results based on user preferred collections according to at least one example embodiment. Operations included in the search result providing method according to at least one example embodiment may be performed by a search result providing system of FIGS. 1 through 6.

In operation S210, the search result providing system may generate, that is, configure a preferred collection list using one or more collections selected by a user. The search result providing system may provide a function that enables the user to directly select a desired search area on which the user desires to view through a mobile search or a web search, and may generate a preferred collection list of the user using a collection selected through the function. For example, if the user conducts a search at a terminal that stores preferred collection information of the user as login information, cookie, etc., the search result providing system may automatically generate a preferred collection list of the user with respect to all of queries. As another example, the search result providing system may generate a preferred collection list of a user with respect to a query that includes a keyword together with a predefined identifier, for example, @.

In operation 5220, the search result providing system may sort and provide search results about the keyword input from the user in an integrated search environment, in the preferred collection list generated in operation S210.

Hereinafter, examples of a process of selecting a preferred collection in an integrated search environment will be described.

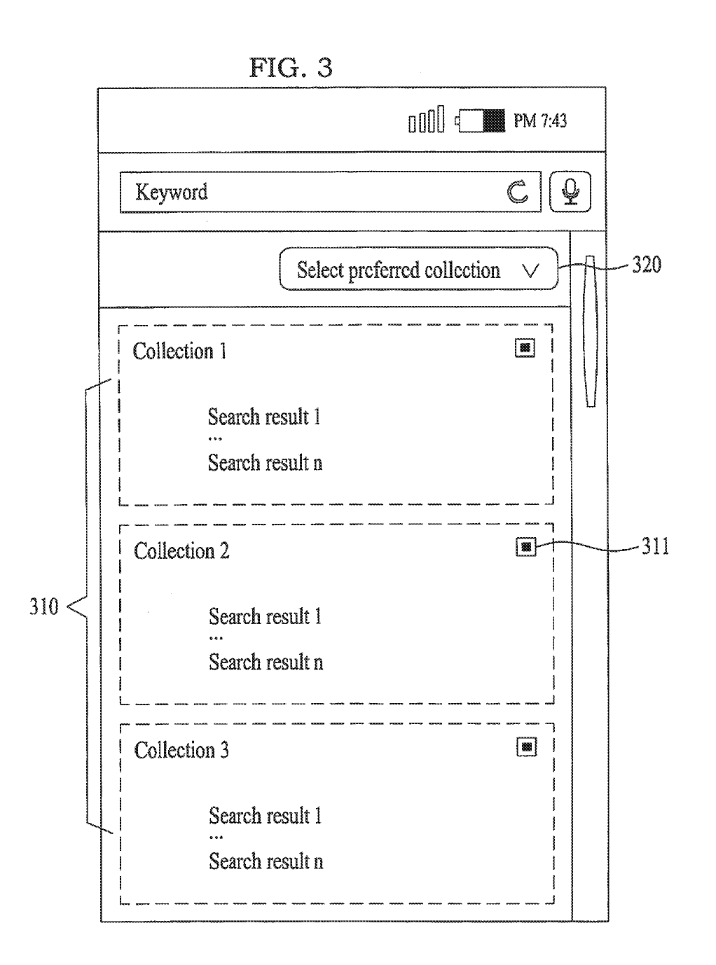

FIG. 3 illustrates an example of a service screen for displaying integrated search results about a keyword according to at least one example embodiment. An initial integrated search screen provides search results by displaying entire collections, for example, collection 1, collection 2, collection 3, etc., 310 in a state in which a preferred collection is not selected by a user. Here, a function of determining whether to perform a display is provided for each collection. For example, a selection icon 311 for determining whether to perform a display (ON/OFF) may be activated as a toggle on a right side of a collection area name. On the initial integrated search screen, all of the selection icons 311 for the respective collections may be maintained in an ON state. Thus, the user may directly input a selection for each collection using the selection icon 311. Also, a separate layer (hereinafter, a collection selection page) capable of selecting a preference or a non-preference may be generated for each collection. A preferred collection selection menu 320 for connecting to the collection selection page may be provided on the initial integrated search screen.

The user may select a preferred collection using the selection icon 311 on the initial integrated search screen, or may select a preferred collection by connecting to the collection selection page using the preferred collection selection menu 320. In addition, a preferred collection selection function may be supported by configuring the collection selection page to interact with a personalized page, for example, an environment setting page, etc., associated with the user.

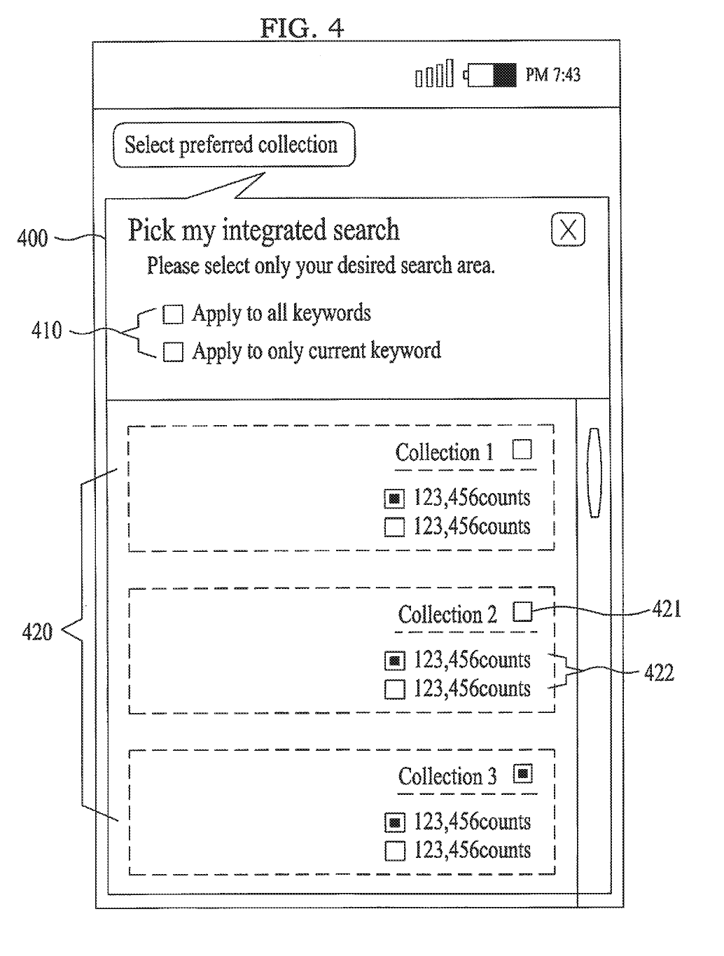

FIG. 4 illustrates an example of a collection selection page 400 configured using a separate layer to select a preferred collection according to at least one example embodiment.

The collection selection page 400 may provide a function of setting a range of a keyword to apply a preferred collection selected by a user. For example, the collection selection page 400 may include selection boxes 410 that enable the user to determine whether to apply a preferred collection to entire keywords or only to a current keyword.

The collection selection page 400 may provide an all-collection list 420 so that the user may select a preferred collection. A collection list associated with a keyword is displayed on the initial integrated search screen of FIG. 3, whereas a list of all collections in an integrated search may be displayed on the collection selection page 400.

A function of determining whether to perform a display may be provided for each collection on a page area on which the all-collection list 420 is displayed. For example, a selection icon 421 for determining whether to perform a display (ON/OFF) may be activated as a toggle on a right of a collection area name. On the page area, all of the selection icons 421 for the respective collections may be maintained in an ON state, or may be maintained in an OFF state. Thus, the user may directly input a selection on a preference/non-preference for each collection using the selection icon 421.

Also, statistical information 422 associated with each collection may be provided for each collection as reference information used for the user to select a collection on the page area on which the all-collection list 420 is displayed. For example, a number of users having selected a corresponding collection as a preferred collection, a number of users having not selected a corresponding collection as a preferred collection, etc., may be provided as statistical information. Alternatively, a variety of statistical data, such as a preference ratio, a click ratio, etc., based on an age, a gender, etc., may be provided as statistical information.

Further, at least one collection selected from among entire collections based on a predetermined criterion may be recommended to the user as reference information on the collection selection page. For example, the search result providing system may extract personal information of the user from login information, cookie, etc., and may recommend the user collections preferred by other users belonging to a similar range, for example, users of similar age, users of the same gender, etc., as recommend collections, based on the extracted personal information.

If the user selects a plurality of collections as preferred collections, the collection selection page may provide a function of selecting order of the selected collections. For example, the search result providing system may sort the preferred collections in order in which the collections are selected, in sequential order input from the user, etc.

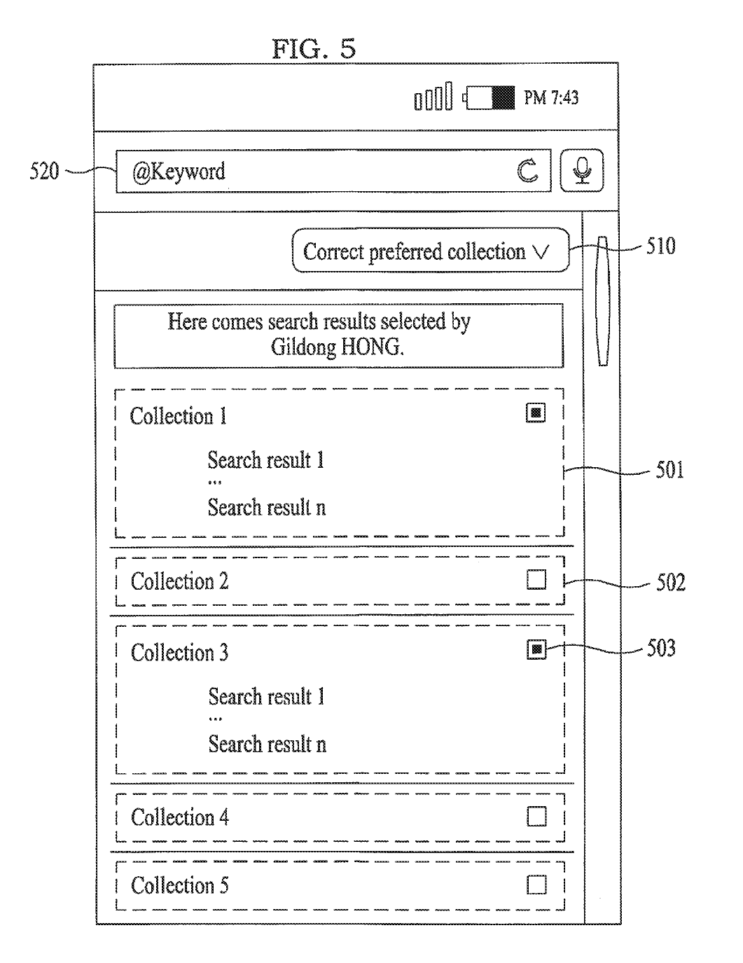

FIG. 5 illustrates an example of an integrated search screen for displaying search results based on a user preferred collection according to at least one example embodiment. Here, it is assumed that collection 1 and collection 3 are selected as preferred collections by the user. For example, among collections associated with a keyword, a collection present in a preferred collection list of a user may be marked to be in an unfold state 501 in which search results are displayed on the integrated search screen. A collection absent in the preferred collection list of the user may be marked to be in a fold state 502 in which search results are not displayed on the integrated search screen. Here, in the fold state 502, only abstract information including a collection name is displayed and search results are not displayed on the integrated search screen. The integrated search screen provides a selection icon 503 for determining whether to perform a display is provided for each collection area on the integrated search screen. A state may be switched between the unfold state 501 and the fold state 502 for each collection using the selection icon 503. That is, in response to an input of the selection icon 503 on the collection area in the unfold state 501, the corresponding collection may be switched from the unfold state 501 to the fold state 502. In response to an input of the selection icon 503 on the collection area in the fold state 502, the corresponding collection may be switched from the fold state 502 to the unfold state 501.

In contrast, among collections associated with the keyword, a collection present in the preferred collection list of the user may be marked to be in the unfold state 501 in which the search results are displayed on the integrated search screen. A collection absent in the preferred collection list of the user may be marked to be in a hide state in which all of information about the collection is not displayed on the integrated search screen.

Also, a “correct preferred collection” menu 510 may be provided on the integrated search screen so that the user may correct a preferred collection. The user may verify and correct the user's preferred collection by connecting to the collection selection page of FIG. 4 through the “correct preferred collection” menu 510 on the integrated search screen.

Referring to FIG. 5, if login information or cookie on preferred collection information of the user is present, the search result providing system may provide search results based on collections preferred by the user in response to a query starting with a specific identifier, for example, @. For example, in response to an input of a keyword that includes @ through a keyword input box 520, search results may be sorted based on only collections preferred by the user among the entire collections associated with the keyword and thereby displayed on the integrated search screen. In response to an input of only a keyword without @, search results may be sorted and displayed on the integrated search screen using a list of all collections associated with the keyword in the aforementioned manner.

The search result providing method may include a further reduced number of operations or additional operations based on the detailed description made with reference to FIGS. 1 through 5. Also, two or more operations may be combined or order or positions thereof may be changed.

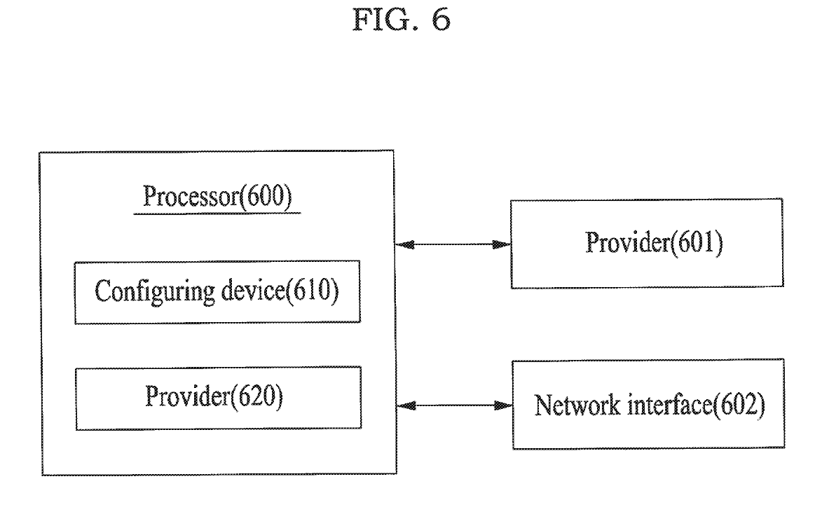

FIG. 6 is a block diagram illustrating a search result providing system for providing search results based on user preferred collections according to at least one example embodiment. Referring to FIG. 6, the search result providing system may include a processor 600 including a configuring device 610 and a provider 620, a memory 601, and a network interface 602.

The memory 601 may store a program including an instruction corresponding to a routine of a search service that includes a collection selection function. A search service according to at least some example embodiments provides integrated search results corresponding to a search query of a user and may display integrated search results based on collections preferred by each user. Operations performed by the search result providing system of FIGS. 1 through 5 may be executed by the program stored in the memory 601. For example, the memory 601 may be a hard disk, a solid state disk (SSD), a secure digital (SD) card, and other storage media.

The network interface 602 may couple the search result providing system with a network for communication with user terminals using the search service that includes the collection selection function.

The processor 600 refers to an apparatus that operates in response to an instruction of the program stored in the memory 601, and may include a microprocessor, such as a central processing unit (CPU) and the like. Hereinafter, a configuration of the processor 600 will be described.

The configuring device 610 may provide a function that enables the user to directly select a search area that the user desires to view through a mobile search or a web search. That is, the configuring device 610 may provide a function of determining whether to perform a display for each collection of entire collections provided through the integrated search. A collection selected by the user through the function may be selected as a preferred collection of the user.

Here, the configuring device 610 may provide statistical information associated with each collection for each collection as reference information used for the user to select a collection. For example, a number of users having selected a collection as a preferred collection, a number of users that having not selected a collection as a preferred collection, etc., may be provided as the statistical information. Alternatively, a variety of statistical data, such as a preference ratio, a click ratio, etc., based on an age, a gender, and the like may be provided as the statistical information.

Also, the configuring device 610 may recommend the user at least one collection selected from among entire collections based on a predetermined criterion as reference information used for the user to select a collection. For example, the configuring device 610 may extract personal information of the user from login information, cookie, and the like, and may recommend the user collections preferred by other users belonging to a similar range, for example, users of similar age, users of the same genera, etc., as recommend collections, based on the extracted personal information.

Also, if the user selects a plurality of collections as preferred collections, the configuring device 610 may provide a function of setting order of the selected collections. For example, the configuring device 610 may sort the selected collections in order in which the collections are selected by the user, in sequential order input from the user, etc.

The configuring device 610 may provide a function of setting a range of a keyword to apply a preferred collection of the user. For example, the configuring device 610 may support the user to determine whether to apply a preferred collection to entire keywords or only to a current keyword.

The configuring device 610 may generate, that is, configure a preferred collection list of the user using a collection selected by the user through the collection selection function. For example, if the user conducts a search at a terminal that stores preferred collection information of the user as login information, cookie, etc., the configuring device 610 may automatically generate a preferred collection list of the user with respect to all of the queries. As another example, the configuring device 610 may generate a preferred collection list of the user only with respect to a query that includes a keyword together with a predefined identifier, for example, @. For example, in response to an input of a keyword starting with @ on the integrated search screen, the configuring device 610 may generate, that is, configure a collection list so that only a user preferred collection among the entire collections associated with the keyword may be displayed. In response to an input of a keyword without @, the configuring device 610 may generate a collection list so that a list of all collections associated with the keyword may be displayed.

The provider 620 may sort and provide search results about the keyword input from the user in an integrated search environment using the preferred collection list generated through the configuring device 610. That is, the provider 620 may provide search results that are displayed based on user preferred collections that the user desires to view.

For example, the provider 620 may mark a collection present in the preferred collection list of the user among collections associated with the keyword to be in an unfold state in which search results are displayed, and may display a collection absent in the preferred collection list of the user to be in a fold state in which abstract information including a collection name is displayed and search results are not displayed. Here, the search result screen may provide a function capable of switching a state between the unfold state and the fold state for each collection area.

As another example, the provider 620 may mark a collection present in the preferred collection list of the user among collections associated with the keyword to be in an unfold state in which search results are displayed and may mark a collection absent in the preferred collection list of the user to be in a hidden state in which all of information about the collection is hidden.

Accordingly, the search result providing system configured as above enables a user to directly determine whether to perform a display for each collection and thereby provide search results based on user preferred collections.

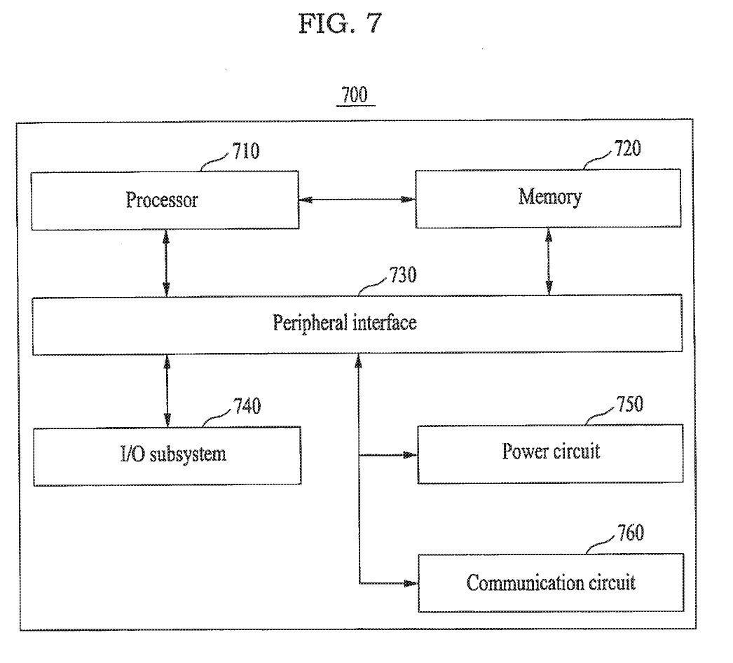

FIG. 7 is a block diagram illustrating a configuration of a computer system corresponding to a user terminal according to at least one example embodiments. Referring to FIG. 7, a computer system 700 may include at least one processor 710, a memory 720, a peripheral interface 730, an input/output (I/O) subsystem 740, a power circuit 750, and a communication circuit 760.

The example embodiment of FIG. 7 is provided as an example of the computer system 700 only. The computer system 700 may have a configuration or an arrangement in which an additional component is further provided or two or more components are coupled each other. For example, a computer system for a mobile terminal may further include a touch screen, a sensor, etc., in addition to the components of FIG. 7. A circuit for radio frequency (RF) communication may be included in the communication circuit 760. Components includable in the computer system 400 may be configured as hardware that includes one or more integrated circuits specified for at least one signal processing or application, software, or a combination of hardware and software.

The memory 720 may include, for example, a high-speed random access memory (HSRAM), a magnetic disk, a static random access memory (SRAM), a dynamic RAM (DRAM), read only memory (ROM), a flash memory, and a non-volatile memory. The memory 720 may include a software module, an instruction set, or a variety of data required for an operation of the computer system 700. Here, an access from another component, such as the processor 710 and the peripheral interface 730, to the memory 720 may be controlled by the processor 710.

The peripheral interface 730 may couple an input device and/or an output device of the computer system 700 with the processor 710 and the memory 720. The processor 710 may perform a variety of functions for the computer system 700 and process data by executing the software module or the instruction set stored in the memory 720.

The I/O subsystem 740 may couple various I/O peripheral devices with the peripheral interface 730. For example, the I/O subsystem 740 may include a controller for coupling the peripheral interface 730 and a peripheral device, such as a monitor, a keyboard, a mouse, a printer, and a touch screen or a sensor depending on a necessity. The I/O peripheral devices may be coupled with the peripheral interface 730 without using the I/O subsystem 740.

The power circuit 750 may supply a power to all of or a portion of components of a terminal. For example, the power circuit 750 may include a power management system, at least one power source such as a battery and alternating circuit (AC), a charge system, a power failure detection circuit, a power converter or inverter, a power status indicator, or other components for creating, managing and distributing the power.

The communication circuit 760 enables communication with another computer system using at least one external port. Alternatively, as described above, the communication circuit 760 may enable communication with another computer system by including an RF circuit and thereby transmitting and receiving an RF signal known as an electromagnetic signal.

The methods according to example embodiments may be configured in program instructions executable through a variety of computer systems and may be recorded in a non-transitory computer-readable recording medium.

The program according to the example embodiments may be configured as a PC-based program or an application exclusive for a mobile terminal. Herein, an app for search may be configured in an independently operating program form, or may be configured in an in-app form of a specific application to be operable on the application.

The methods according to example embodiments may be performed in such a manner that an application associated with a server system that provides a search service controls a user terminal. For example, the application may include a module configured to control the user terminal to generate a preferred collision list associated with a keyword using one or more selected collections; and a module configured to control the user terminal to sort and output search results about the keyword in the preferred collection list. The application may be installed on the user terminal through a file provided from a file distribution system. For example, the file distribution system may include a file transmitter (not shown) configured to transmit the file in response to a request of the user terminal.

According to some example embodiments, since a user may directly select a preferred collection and a non-preferred collection from among integrated search results, it is possible to provide an individual-oriented search area. According to some example embodiments, since search results may be provided based on collection information selected in response to a user selection on a preferred collection, it is possible to enhance a service satisfaction and the quality of integrated search by applying user requirements for search results.

The processing device described herein may be implemented using hardware components, software components, and/or a combination thereof. For example, the processing device and the component described herein may be implemented using one or more general-purpose or special purpose computers, such as, for example, a processor, a controller and an arithmetic logic unit (ALU), a digital signal processor, a microcomputer, a field programmable gate array (FPGA), a programmable logic unit (PLU), a microprocessor, or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will be appreciated that a processing device may include multiple processing elements and/or multiple types of processing elements. For example, a processing device may include multiple processors or a processor and a controller. In addition, different processing configurations are possible, such as parallel processors.

The software may include a computer program, a piece of code, an instruction, or some combination thereof, for independently or collectively instructing or configuring the processing device to operate as desired. Software and/or data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more computer readable recording mediums.

The methods according to the example embodiments may be recorded in non-transitory computer-readable media in a form of program instructions executable through a variety of computer devices. The media may also include, alone or in combination with the program instructions, data files, data structures, and the like. The program instructions stored in the media and may be those specially designed and constructed for the example embodiments, or they may be of the kind well-known and available to those having skill in the computer software arts. Examples of non-transitory computer-readable media include magnetic media such as hard disks, floppy disks, and magnetic tape; optical media such as CD ROM disks and DVD; magneto-optical media such as floptical disks; and hardware devices that are specially designed to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be to act as one or more software modules in order to perform the operations of the above-described embodiments.

While the foregoing example embodiments have been described and illustrated, it will be apparent to one skilled in the art that various changes and modifications in forms and details may be made in these examples without departing from the sprit and scope of the claims and their equivalents. For example, suitable results may be achieved if the described techniques are performed in different order, and/or if components in a described system, architecture, device, or circuit, etc., are combined in a different manner, and/or replaced or supplemented by other components or their equivalents.

Therefore, the scope of the disclosure is defined not by the detailed description, but by the claims and their equivalents, and all variations within the scope of the claims and their equivalents are to be construed as being included in the disclosure.

1. A search result providing method, the method comprising:
generating, using at least one processor, a preferred collection list associated with at least one keyword using one or more selected collections from a plurality of collections;
sorting, using the at least one processor, search results about the at least one keyword in the preferred collection list; and
transmitting, using the at least one processor, the sorted search results.

2. The method of claim 1, further comprising:
determining, using the at least one processor, whether to display each collection of the plurality of collections, prior to the generating of the preferred collection list.

3. The method of claim 2, wherein the determining whether to display comprises generating statistical information for each collection of the plurality of collections.

4. The method of claim 2, wherein the determining whether to display comprises recommending one or more collections selected from the plurality of collections based on personal information of a user.

5. The method of claim 2, wherein the determining whether to display comprises setting an order of each of the collections of the plurality of collections in response to a determination result indicating the display of every collection of the plurality of collections.

6. The method of claim 1, further comprising:
setting, using the at least one processor, a range of keywords for applying the preferred collection list, prior to the generating of the preferred collection list.

7. The method of claim 1, wherein the generating comprises generating the preferred collection list in response to an input of the at least one keyword together with a desired identifier.

8. The method of claim 1, wherein the transmitting the sorted search results comprises:
marking present at least one collection in the preferred collection list among the plurality of collections associated with the at least one keyword, the marking present including indicating that the at least one present collection be in an unfold state, the unfold state including displaying search results associated with the present collection; and
marking absent at least one collection in the preferred collection list among the plurality of collections associated with the at least one keyword, the marking absent including indicating that the at least one absent collection be in a fold state, the fold state including displaying information including a name of the absent collection, and not displaying search results associated with the absent collection.

9. The method of claim 8, wherein the transmitting the sorted search results comprises switching a state between the unfold state and the fold state for each collection of the plurality of collections associated with the at least one keyword.

10. The method of claim 1, wherein the transmitting the sorted search results comprises:
marking present at least one collection in the preferred collection list among the plurality of collections associated with the at least one keyword, the marking present including indicating that the at least one present collection be in an unfold state, the unfold state including displaying search results associated with the present collection; and
marking absent at least one collection in the preferred collection list among the plurality of collections associated with the at least one keyword, the marking absent including indicating that the at least one absent collection be in a hidden state, the hidden state including hiding all information of the absent collection.

11. A search result providing system comprising:
a memory having computer readable instructions stored thereon; and
at least one processor configured to execute the computer readable instructions to,
generate a preferred collection list associated with at least one keyword using one or more selected collections from a plurality of collections, and
search results about the at least one keyword in the preferred collection list, and
transmit the sorted search results.

12. The system of claim 11, wherein the least one processor is configured to determine whether to display each collection of the plurality of collections.

13. The system of claim 12, wherein the at least one processor is configured to generate statistical information for each collection of the plurality of collections.

14. The system of claim 12, wherein the at least one processor is configured to recommend one or more collections selected from the plurality of collections based on personal information of a user.

15. The system of claim 12, wherein the at least one processor is configured to provide a function of setting an order of each of the collections of the plurality of collections in response to a determination result indicating the display of every collection of the plurality of collections.

16. The system of claim 11, wherein the at least one processor is configured to setting a range of keywords for applying the preferred collection list.

17. The system of claim 11, wherein the at least one processor is configured to generate the preferred collection list in response to an input of the at least one keyword together with a desired identifier.

18. The system of claim 11, wherein the at least one processor is configured to:
mark present at least one collection in the preferred collection list among the plurality of collections associated with the at least one keyword, the mark present including indicating that the at least one present collection be in an unfold state, the unfold state including displaying search results associated with the present collection; and
to mark absent at least one collection in the preferred collection list among the plurality of collections associated with the at least one keyword, the mark absent including indicating that the at least one absent collection in a fold state, the fold state including displaying information including a name of the absent collection, and not displaying search results associated with the absent collection.

19. The system of claim 18, wherein the at least one processor is configured to switch a state between the unfold state and the fold state for each collection of the plurality of collections associated with the at least one keyword.

20. The system of claim 11, wherein the at least one processor is configured to:
mark present at least one collection in the preferred collection list among the plurality of collections associated with the at least one keyword, the marking present including indicating that the at least one present collection in an unfold state, the unfold state including displaying search results associated with the present collection; and
mark absent at least one collection in the preferred collection list among the plurality of collections associated with the at least one keyword, the marking absent including indicating that the at least one absent collection be in a hidden state, the hidden state including hiding all information of the absent collection is hidden.

21. (canceled)

22. (canceled)
